(19) United States
(12) Patent Application Publication
(10) Pub. No.: US 2006/0030985 A1
(43) Pub. Date: Feb. 9, 2006

(54) Vehicle recognition using multiple metrics

(75) Inventors: Arthur Lawida, Scottsdale, AZ (US); Ole Sorensen, Phoenix, AZ (US)

Correspondence Address: Robert E. Krebs;Thelen Reid & Priest LLP, P.O. Box 640640, San Jose, CA, 95164-0640, US

(73) Assignees: Active Recognition Technologies Inc.,; a Delaware Corporation

(21) Appl. No.: 10/971,768

(22) Filed: Oct. 21, 2004

Related U.S. Application Data
(60) Provisional application No. 60/514,311, filed on Oct. 24, 2003.

(51) Int. Cl. G06F 19/00

(52) U.S. Cl. 701/35; 701/29

(57) ABSTRACT

Vehicle recognition may be achieved by receiving multiple metrics from one or more vehicle sensors, analyzing the metrics to create a multi-metric vehicle identification profile comprising at least two of the multiple metrics, at least one result of the analyzing, or both, and matching the multi-metric vehicle identification profile against multiple stored vehicle sensor recordings.

### CROSS REFERENCE TO RELATED APPLICATIONS

This application claims the benefit of provisional patent application No. 60/514,311 filed Oct. 24, 2003, entitled “Process, System and Method for Identification of Vehicles Using Multiple Visual Cues”.

### FIELD OF THE INVENTION

The present invention relates to the field of computer science. More particularly, the present invention relates to vehicle recognition using multiple metrics.

### BACKGROUND OF THE INVENTION

Conventional vehicle identification are typically based solely on the use of identifiers attached or added to a vehicle, such as license plate numbers, RFID tags, cards such as smart-cards, and transponder devices of some kind. One or more objects or devices attached to or carried in the vehicle typically present a numeric or alphanumeric or at least a unique binary series of some kind as a vehicle identifier. Unfortunately, it is often possible to remove objects of devices producing this identity from the vehicle and attach the objects to other vehicles. It also possible to copy, counterfeit or spoof the objects and attach to other vehicles. Additionally, the objects, sometimes present incomplete identifiers, e.g., because of occluded, or partially occluded characters of a license plate. Consequently, such methods are not truly vehicle recognition, but are methods of identifying the associated objects or devices that are intended to be used in conjunction with vehicles. Accordingly, a need exists for an improved solution for vehicle recognition.

### SUMMARY OF THE INVENTION

Vehicle recognition may be achieved by receiving multiple metrics from one or more vehicle sensors, analyzing the metrics to create a multi-metric vehicle identification profile comprising at least two of the multiple metrics, at least one result of the analyzing, or both, and matching the multi-metric vehicle identification profile against multiple stored vehicle sensor recordings.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram of a computer system suitable for implementing aspects of the present invention.

FIG. 2 is a block diagram that illustrates a system for vehicle recognition using multiple metrics in accordance with one embodiment of the present invention.

FIG. 3 is a block diagram that illustrates flashlight/camera application system comprising a vehicle recognition system in accordance with one embodiment of the present invention.

FIG. 4 is a block diagram that illustrates a vehicle recognition system from a logical data store perspective in accordance with one embodiment of the present invention.

FIG. 5 is a high-level flow diagram that illustrates a method for vehicle recognition in accordance with one embodiment of the present invention.

FIG. 6 is a block diagram that illustrates a vehicle recognition system from the perspective of basic functions in accordance with one of the present invention.

FIG. 7 is a block diagram that illustrates color sensing and matching in accordance with one embodiment of the present invention.

FIG. 8 is a schema diagram that illustrates metrics for use in vehicle identification in accordance with embodiments of the present invention.

FIG. 9 is a block diagram that illustrates a method for vehicle recognition in accordance with one embodiment of the present invention.

FIG. 10 is a block diagram that illustrates data relationships for category recognition of kinds of objects and/or vehicles in accordance with one embodiment of the present invention.

FIG. 11 is a block diagram that illustrates vehicle identification based at least in part on the vehicle's color, shape, and license number in accordance with one embodiment of the present invention.

FIG. 12 is a schema diagram that illustrates a logical relationship of kinds of metrics in accordance with one embodiment of the present invention.

FIG. 13 is a flow diagram that illustrates a method for vehicle recognition in accordance with one embodiment of the present invention.

FIG. 14 is a flow diagram that illustrates a method for license plate and license number metric processing in accordance with one embodiment of the present invention.

FIG. 15 is a flow diagram that illustrates a method for license plate and license number metric processing in accordance with one embodiment of the present invention. FIG. 15 is a continuation of FIG. 14.

### DETAILED DESCRIPTION

Embodiments of the present invention are described herein in the context of a method and apparatus for vehicle recognition using multiple metrics. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

According to one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on computers (such as running windows XP, XP PRO, 2000 K (other windows), Linux or Unix, or Apple OS X based systems). Different implementations may be used and may include other types of operating systems, computing platforms, computer programs, firmware, computer languages and/or general-purpose machines; and may also include various CCD cameras, color and/or infrared cameras, analogue and/or digital, video and/or still, mobile and/or stationary, and other types of sensor devices. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

According to one embodiment of the present invention, the method may be implemented on a data processing computer such as a personal computer, workstation computer, mainframe computer, or high performance server running an OS such as Solaris® available from Sun Microsystems, Inc. of Santa Clara, Calif., Microsoft® Windows® XP and Windows® 2000, available from Microsoft Corporation of Redmond, Wash., or various versions of the Unix operating system such as Linux available from a number of vendors. The method may also be implemented on a color or infrared camera such as Extreme CCTV or CAMLITE. The method may also be implemented on a mobile device running an OS such as Windows® CE, available from Microsoft Corporation of Redmond, Wash., Symbian OS™, available from Symbian Ltd of London, UK, Palm OS®, available from PalmSource, Inc. of Sunnyvale, Calif., and various embedded Linux operating systems. Embedded Linux operating systems are available from vendors including MontaVista Software, Inc. of Sunnyvale, Calif., and FSMLabs, Inc. of Socorro, N. Mex. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks.

In the context of the present invention, the term “connection means” includes any means by which a first one or more devices communicate with a second one or more devices. In more detail, a connection means includes networks and direct connection mechanisms, parallel data busses, and serial data busses.

In the context of the present invention, the term “network” includes local area networks, wide area networks, metro area networks, residential networks, corporate networks, inter-networks, the Internet, the World Wide Web, cable television systems, telephone systems, wireless telecommunications systems, fiber optic networks, token ring networks, Ethernet networks, ATM networks, frame relay networks, satellite communications systems, and the like. Such networks are well known in the art and consequently are not further described here.

In the context of the present invention, the term “identifier” describes an ordered series of one or more numbers, characters, symbols, or the like. More generally, an “identifier” describes any entity that can be represented by one or more bits. In the context of the present invention, vehicle or object identity is a multi-metric identity with two or more metrics comprising a multi-metric identity profile for vehicle or object recognition, which profile may comprise identifiers among the metrics.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present invention, the term “data stores” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

In the context of the present invention, the term “user interface” describes any device or group of devices for presenting and/or receiving information and/or directions to and/or from persons. A user interface may comprise a means to present information to persons, such as a visual display projector or screen, a loudspeaker, a light or system of lights, a printer, a Braille device, a vibrating device, or the like. A user interface may also include a means to receive information or directions from persons, such as one or more or combinations of buttons, keys, levers, switches, knobs, touch pads, touch screens, microphones, speech detectors, motion detectors, cameras, and light detectors. Exemplary user interfaces comprise pagers, mobile phones, desktop computers, laptop computers, handheld and palm computers, personal digital assistants (PDAs), cathode-ray tubes (CRTs), keyboards, keypads, liquid crystal displays (LCDs), control panels, horns, sirens, alarms, printers, speakers, mouse devices, consoles, and speech recognition devices.

In the context of the present invention, the term “system” describes any computer information and/or control device, devices or network of devices, of hardware and/or software, comprising processor means, data storage means, program means, and/or user interface means, which is adapted to communicate with the embodiments of the present invention, via one or more data networks or connections, and is adapted for use in conjunction with the embodiments of the present invention.

In the context of the present invention, the term “vehicle” describes any object that is a conveyance adapted to transport one or more people or objects. A vehicle may be piloted by a person riding or occupying the vehicle. Alternatively, a vehicle may be piloted by a person remotely, or assisted by computer control, auto-pilot systems, or both. Exemplary vehicles comprise ground craft such as cars, automobiles, trucks, trailers, vans, SUVs, motorcycles, all-terrain vehicles (ATVs), carts, scooters, bicycles, military vehicles, heavy equipment, trains, cable cars, snowmobiles, and the like. Exemplary vehicles also comprise watercraft such as submersibles, amphibious craft, ships and boats, hydroplanes, personal watercraft, and the like. Exemplary vehicles also comprise aircraft such as airplanes, jet aircraft, gliders, balloons, helicopters, and the like. Exemplary vehicles also comprise spacecraft such as shuttles, stations, rockets, satellites, and the like. Exemplary vehicles also comprise containers such as boxes, shipping containers, and the like.

In the context of the present invention, the term “alarm” describes any means for alerting, notifying, or getting the attention of persons. An alarm may be adapted to indicate a danger, a warning, urgency, a need for alert, attention, or import. Exemplary alarms comprise sirens, horns, ring tones, beeps, lights, blinking lights, flashing lights, vibrations, print outs, gauges, symbols, and visual displays, and the like.

In the context of the present invention, the term “access device” describes any device adapted to indicate, direct, or control (i.e., grant, deny, or restrict) the presence of or access for one or more vehicles in their movement from one area to another. Such areas comprise, by way of example, parking areas, driveways, roads, toll roads, railways, cableways, open waters, waterways, airways, space ways, docks, marinas, airports, space ports, trails, paths, bridges, locks, gateways, buildings, ferries, parks, fields, off-road areas, and the like. Such ‘access’ may also comprise access to one or more services, such as payment, transport, shipping, storage, revenue management, toll, membership, accounting, monitoring, tracking, notification, communication and/or other services known by those of ordinary skill in the art.

In the context of the present invention, the terms “metric” and/or “clue” describe any relatively invariant aspect or characteristic of any kind of vehicle that can be sensed, measured, or detected so as to be used in combination with other metrics or clues to assist in identification and/or recognition of that particular vehicle and/or of that type and/or make and model of vehicle. Exemplary metrics or clues comprise color, lighting adjusted color, shape, texture, type, make and model, license plate, license plate state of origin, license plate type, license number, partial license numbers, images, other visual tokens, other numbers, codes, identifiers, names, bar codes, RFID information, card and/or smart-card information, transponder information, magnetic patterns, heat metrics, sound patterns, vibration metrics, and motion.

In the context of the present invention, the term “sensor” describes any device adapted to sense at least one metric of at least one kind of vehicle. Sensors may be visual sensors or non-visual sensors. Exemplary visual sensors comprise color cameras and infrared cameras. Such cameras may be video cameras, still cameras, or both. Such cameras may also be analog cameras, digital cameras, or both. Non-visual sensors comprise sensors for sensing either passive or active metrics of a vehicle. Exemplary non-visual passive sensors comprise magnetic sensors, heat sensors, sound sensors, microphones, vibration sensors, motion detectors, and the like. Exemplary non-visual active sensors comprise RFID readers, smart-card readers, transponder devices, and other card and device readers.

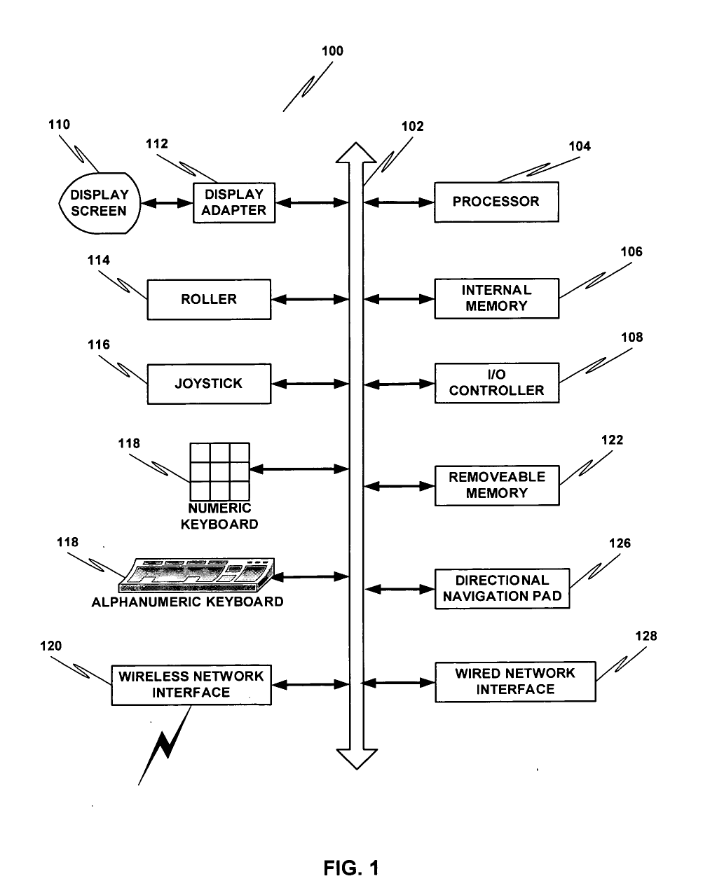

FIG. 1 depicts a block diagram of a computer system 100 suitable for implementing aspects of the present invention. As shown in FIG. 1, computer system 100 comprises a bus 102 which interconnects major subsystems such as a central processor 104, a system memory 106 (typically RAM), an input/output (I/O) controller 108, an external device such as a display screen 110 via display adapter 112, serial ports 114 and 116, a keyboard 118, a fixed disk drive 120, a floppy disk drive 122 operative to receive a floppy disk 124, and a CD-ROM player 126 operative to receive a CD-ROM 128. Many other devices can be connected, such as a pointing device 130 (e.g., a mouse) connected via serial port 114 and a modem 132 connected via serial port 116. Modem 132 may provide a direct connection to a remote server via a telephone link or to the Internet via a POP (point of presence). Alternatively, a network interface adapter 134 may be used to interface to a local or wide area network using any network interface system known to those skilled in the art (e.g., Ethernet, xDSL, AppleTalk™).

Many other devices or subsystems (not shown) may be connected in a similar manner. Also, it is not necessary for all of the devices shown in FIG. 1 to be present to practice the present invention, as discussed below. Furthermore, the devices and subsystems may be interconnected in different ways from that shown in FIG. 1. The operation of a computer system such as that shown in FIG. 1 is readily known in the art and is not discussed in detail in this application, so as not to overcomplicate the present discussion. Code to implement the present invention may be operably disposed in system memory 106 or stored on storage media such as fixed disk 120, floppy disk 124 or CD-ROM 128.

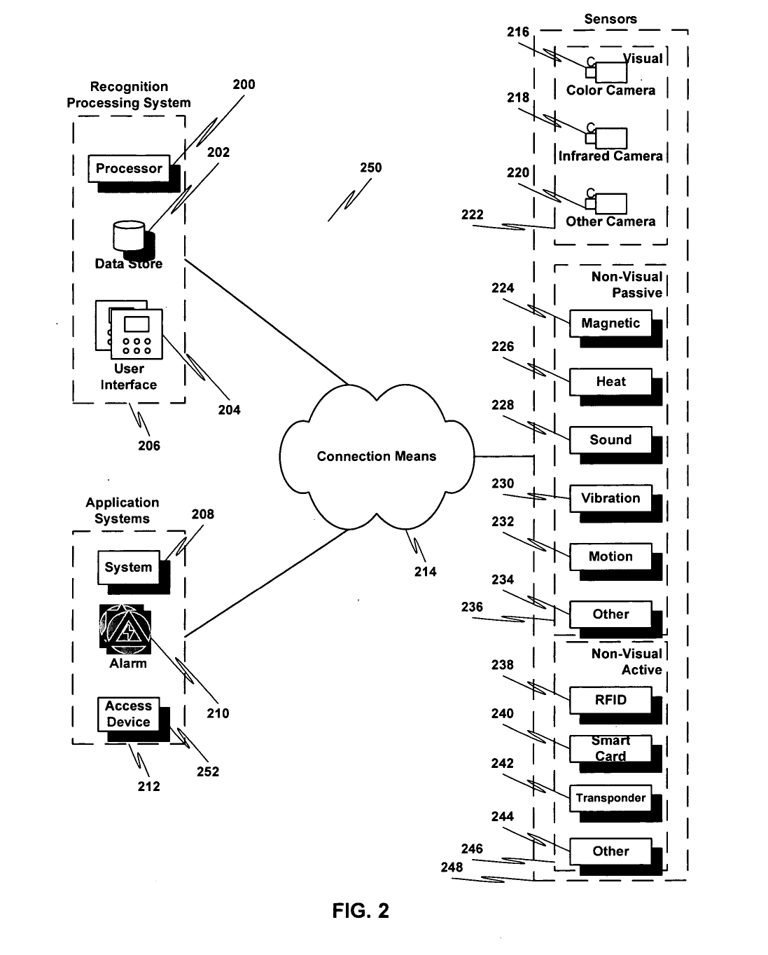

Turning now to FIG. 2, a block diagram that illustrates a system for vehicle recognition using multiple metrics in accordance with one embodiment of the present invention is presented. As shown in FIG. 2, vehicle recognition system 250 comprises at least one recognition processing system 206 communicatively coupled via connection means 214 to two or more sensors 248. The two or more sensors 248 are adapted to sense at least one metric aspect of at least one kind of vehicle. The vehicles may comprise vehicles of interest to users of the recognition system. By way of example, the vehicles may comprise vehicles considered valid, vehicles considered invalid, vehicles which possibly could be allowed, assisted with, and/or denied access to one or more areas, one or more services, or both; for some uses, e.g., security, such vehicles may be considered dangerous and if not denied access in a timely or satisfying fashion such vehicle's monitored presence and/or behavior may be cause for possibly urgent action. Also, a vehicle with mismatched clues especially mismatched identifiers or an identifier mismatched with any other clues may present a danger.

According to one embodiment of the present invention, recognition processing system 206 of vehicle recognition system 250 comprises one or more processors 200, one or more data stores 202, and one or more user interfaces 204 communicatively coupled via connection means 214. Vehicle recognition system 250 may also comprise one or more application systems 212. The one or more application systems 212 comprise any of one or more systems 208, one or more alarms 210, and one or more access devices 212 also communicatively coupled via connection means 214.

According to one embodiment of the present invention, the vehicle recognition system 250 comprises two or more sensors 248. In accordance with a further embodiment of the present invention, the two or more sensors comprise a color video camera and an infrared video camera.

According to another embodiment of the present invention, the vehicle recognition system 250 comprises one or more sensors 248 adapted to sense two or more vehicle metrics. By way of example, a color camera 216 may be adapted to sense color, shape, and license number.

According to one embodiment of the present invention, the two or more metrics may be obtained from various arrangements of the use of the images from the color and infrared cameras depending on the situation, for example, on the lighting conditions, or on the configuration of the system, or on the analysis of the video images from the cameras.

According to one embodiment of the present invention, a vehicle recognition system may have one or more sensors. According to a further embodiment of the present invention, a vehicle recognition system comprises color camera sensor and at least one other sensor.

In the context of the present invention, the connections, and/or networks of the recognition processing system, application systems, their components, and sensors, may be one or more connections and/or networks, shared, or not shared in any configurations among the components. Thus also in the context of the present invention, the components, hardware and/or software, may be physically and/or logically co-located or distributed or incorporated among each other or incorporated in other systems in any configuration.

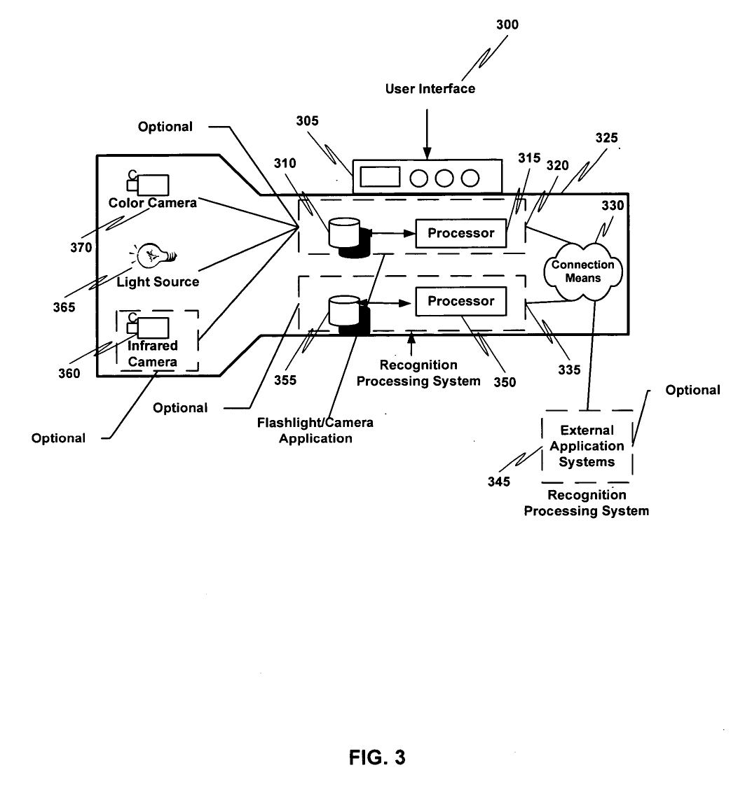

Turning now to FIG. 3, a block diagram that illustrates flashlight/camera application system comprising a vehicle recognition system in accordance with one embodiment of the present invention is presented. FIG. 3 illustrates the system of FIG. 2 embodied in a self-contained apparatus. As shown in FIG. 3, this example incorporates multiple visual metrics with two sensors, a color camera 370, and optional infrared camera 360.

FIG. 3 shows the processor 350 and data store 355 of the recognition processing system 335 to be physically distinct from the system of the flashlight/camera application 320, the recognition processing system could also be embodied by full or partial incorporation in the same processor and/or data store with the light application. According to another embodiment of the present invention, at least part of the recognition processing system 335 is comprised by external application system(s) 345 of FIG. 3. According to another embodiment of the present invention, the sensors (370, 360) are partially in the flashlight 325 and partially external to the flashlight 325.

In the context of the present invention the term “application system” comprises by way of example systems for security, access control, gate access, parking access, parking lot management and payment, driveway or parking drive through access, toll roads access and payment, toll revenue management, road surveillance, site surveillance, investigative surveillance, security video analysis, building access, locks, waterways, marinas, city parking, zone parking, parking revenue management, police use, military use, corporate use, residential use, traffic management, homeland security, membership access, use monitoring, vehicle/ID mismatch monitoring, market research, traffic analysis, services delivery, transport, shipping, storage, flow control, container services, and the like.

As FIG. 2 and FIG. 3 in conjunction illustrate, a vehicle recognition system may be, in full or in part, embodied in one or more mobile or stationary systems. Mobile examples comprise personal and/or handheld vehicle or stationary systems, comprising for example incorporation in the flashlight/camera of FIG. 3, a mobile phone, a camera or camera set, a PDA, in any kind of vehicle, for example a car or helicopter, on a trailer or any kind of transportable or luggable apparatus. Stationary examples comprise distributed incorporations, enterprise systems, site or compound systems, toll booths, traffic lights, gates, guard booths, parking lots, marinas, airports, military bases, streets, offices, and homes.

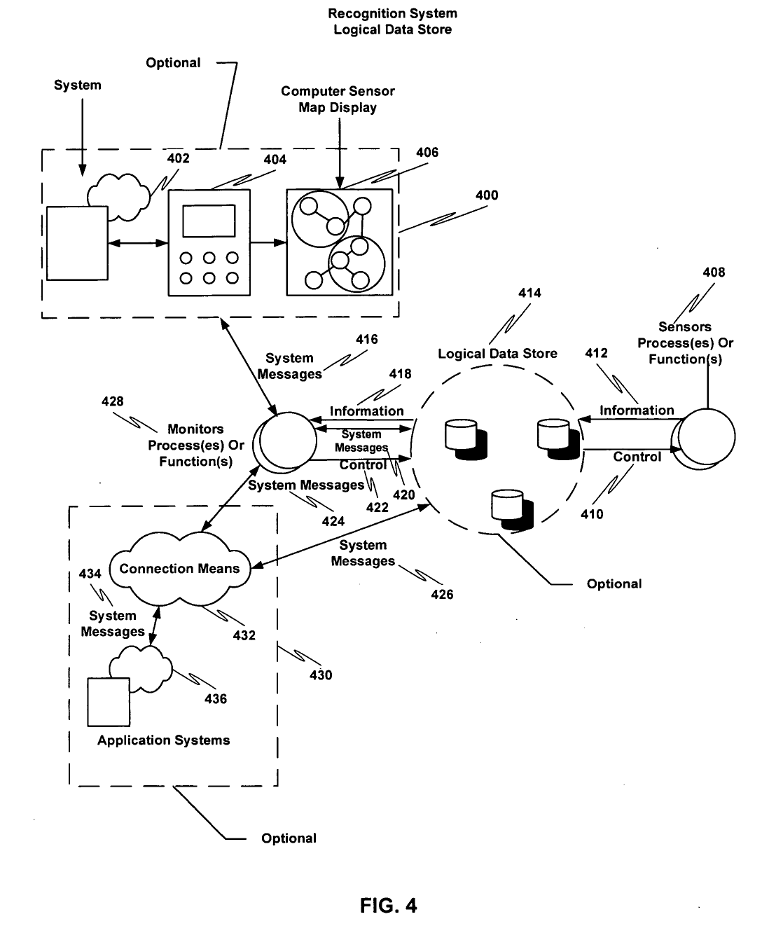

Turning now to FIG. 4, a block diagram that illustrates a vehicle recognition system from a logical data store perspective in accordance with one embodiment of the present invention is presented. As shown in FIG. 4, the sensors 408 are shown as one or more of their corresponding processes or functions. The recognition processing system is illustrated as primarily the corresponding one or more monitor processes or functions 428. The monitors 428 receive or monitor metric and/or other information from the sensors 408. The monitors 428 and or application systems 436 may also send and/or exchange control information to direct, manage and/or control the sensors 408. By way of example, the sensors 408 may be turned on and off, rotated or moved, focused, zoomed, activated, diagnosed, adjusted, configured, rebooted, installed, and de-installed, etc.

According to one embodiment of the present invention, the monitors 428 exchange system messages (424, 434) with one or more application systems 436. As shown, the monitors 428 exchange system messages 416 with at least one user interface 404, either locally or remotely, distributed or incorporated in a system or application system 402. According to one embodiment of the present invention, at least one user interface 404 displays a map 406, in part or in full, of the sensors and, for example, their location, and/or status, etc. According to one embodiment of the present invention, if the monitors 428 detect a vehicle via the sensors 408, the status of that activity will be available in a display 404 so a person can be informed and given the opportunity to recognize the vehicle, direct access control or other activity of, for example, an application system 436 for security and/or access control.

According to one embodiment of the present invention, the monitor function or process 428 processes the sensor metrics of a present vehicle to recognize that vehicle's identity by matching multiple metrics with vehicle profiles in the registration data store 414. The monitors can find either no match, or a match, or one or more possible matches or a mismatch. The monitor function or process 428 then at least presents the match results via system messages (424, 434) to an application system 436, or a user interface 404.

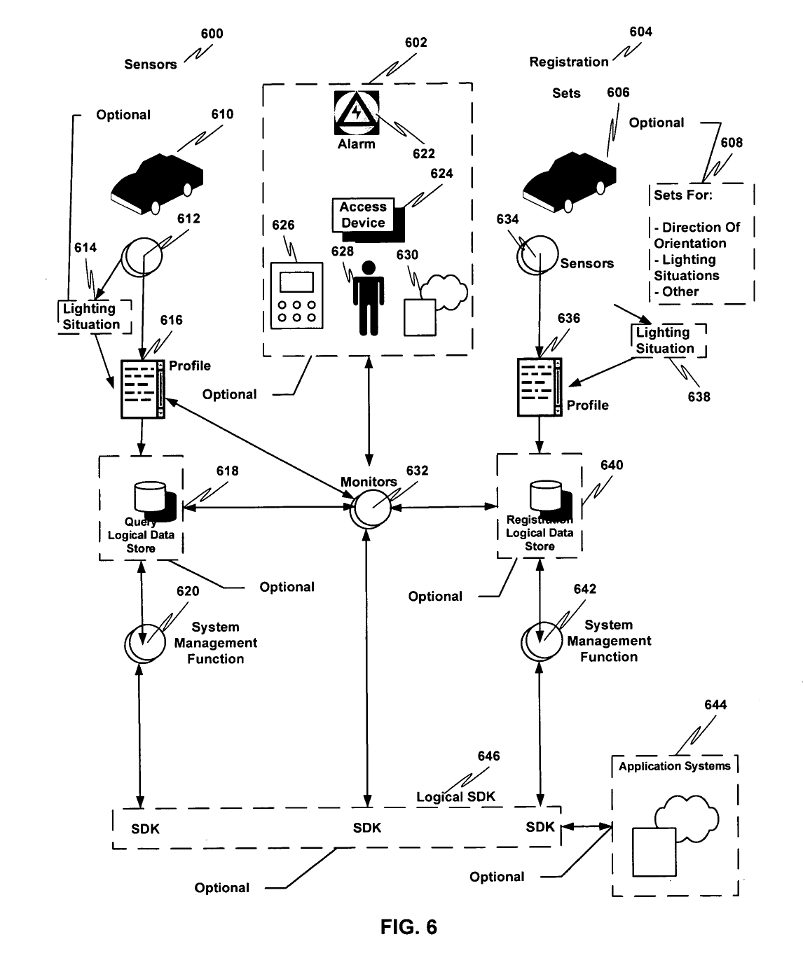

FIG. 4 particularly illustrates that the data store 414 of the recognition processing system may be incorporated discretely, distributed, and/or incorporated with other systems. According to one embodiment of the present invention, and as illustrated below with respect to FIG. 6, the logical data store 414 of the recognition processing system is in two logical parts: a query data store (reference numeral 618 of FIG. 6) associated with the sensor processes and/or functions and a registration data store (reference numeral 640 of FIG. 6).

According to one embodiment of the present invention, the logical data store 414 is partitioned into more logical data stores, for example query logical data stores, registration logical data stores, and application support logical data stores.

According to one embodiment of the present invention, at least part of the information of the logical data store 414 of a vehicle recognition system is incorporated in a third logical data store, that of an application system. By way of example, the query data store could store current vehicle query vehicle profiles, the registration data store could hold registration vehicle profiles and an application system data store could contain registrant information of the registered vehicle owners. The logical query and registration data stores could be implemented in one physical data store or, for example, in one or more parts of a distributed data store. The incorporation flexibility of the current invention supports embodiment of the data store of a vehicle recognition system in tall the configurations of local, remote, physical, logical, network and distributed data stores.

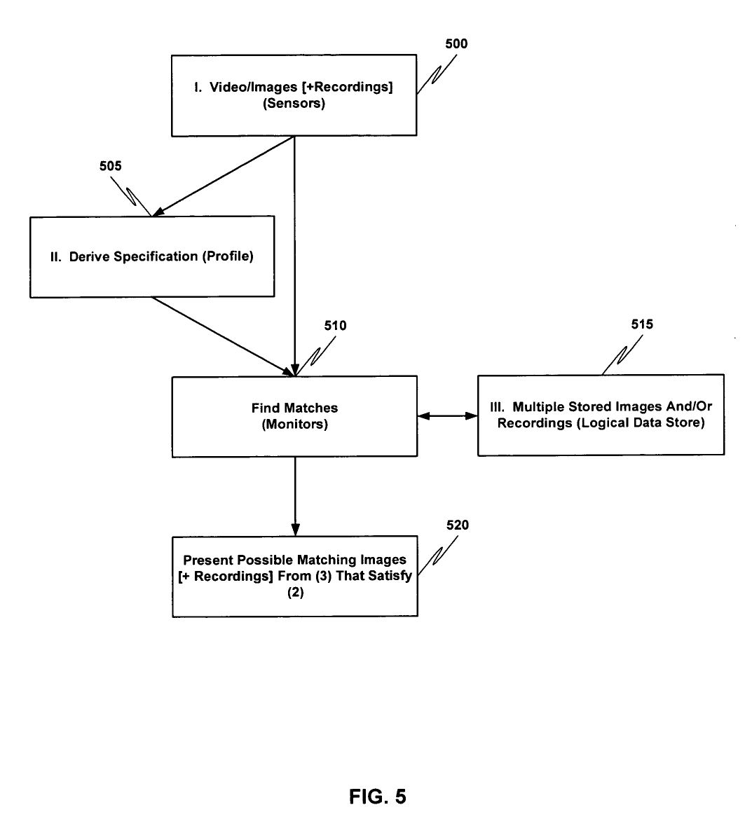

FIG. 4 provides a low-level illustration of a vehicle recognition system represented by FIG. 5. FIG. 5 is a high-level flow diagram that illustrates a method for vehicle recognition in accordance with one embodiment of the present invention. The processes illustrated in FIG. 5 may be implemented in hardware, software, firmware, or a combination thereof. As shown in FIG. 5, I) recorded information generated by one or more sensors (such as video, images recorded by color and infrared cameras, or a combination thereof) (500), flow to II) where a multiple metric vehicle identification profile specification is produced from the recorded information (505), and the recorded information and the specification flow to III (515), a function or process to find matching vehicle information in multiple stored vehicle sensor recordings (such as video images recorded by color and/or infrared cameras, or a combination thereof). The multiple metric vehicle identification profile comprises one or more of (1) at least some of the information generated by the one or more sensors, and (2) a result of analyzing at least some of the information generated by the one or more sensors. According to one embodiment of the present invention, the matching is by monitor functions or processes and the stored vehicle sensor recordings are in a logical data store, as also the specification may be in such a logical data store. According to a further embodiment of the present invention, the results of a possible match or matches or no matches or mismatches is then made available by the monitor functions or processes presenting the results to at least one of user interfaces, application systems, access devices and/or alarms (520). According to one embodiment of the present invention, the results are presented at least to a user interface accompanied by the possibly matching stored image or images from a registration data store, including so a person can be informed and given the opportunity to recognize the vehicle, direct access control or other activity of, for example, an application system 436 for security and/or access control.

Turning now to FIG. 6, a block diagram that illustrates a vehicle recognition system from a perspective of basic functions in accordance with one embodiment of the present invention is presented. As shown in FIG. 6, the monitor function or process 632 is central to the vehicle recognition function, as it processes the query vehicle profiles 616 of multiple sensor metrics to recognize the vehicle 610 by matching that query profile 616 to a multiple metric vehicle identity profile 636 previously stored in the registration data store 640. The monitors present the results of the match. In more detail, the monitors present to at least one of user 628 (directly or via user interfaces 626), systems 630, access devices 624, user alarms 602, application systems 644, and SDKs 646, an indication of whether there was a match, no match, similar matches, or a mismatch, including so that a system, process or person can be informed and given the opportunity to recognize the vehicle, direct access control or other activity of, for example, an application system 436 for security and/or access control.

FIG. 6 also illustrates that for the sensor query profile data store 618 and the registration profile data store 640, and for any such configuration of the vehicle recognition system logical data store, the use of a system management function (620 or 642), single or distributed, providing system and data store management functions of information processing systems as are needed, i.e. comprising any of reporting, backup, restore, queries, file and database management, data entry, front office, back office, and system and application administration and configuration. FIG. 6 further illustrates the use of SDKs (Software Development Kits) 646 and/or APIs (Application Programmer Interfaces) and/or other interfaces that provide access and interface via these to systems and/or application systems in which a vehicle recognition system or some part thereof may be incorporated, or with which it may be communicating, in accordance with one embodiment of the present invention. The data stores (618, 640) may be one or more physical data stores forming a vehicle registration system logical data store (reference numeral 414 of FIG. 4), and so also for the system management functions and SDKs and/or APIs, object libraries, transactional services and other types of software interfaces, system interfaces, or a combination thereof.

FIG. 6 also illustrates support of the basic vehicle recognition operational functions of registration and sensing. In order to identify or find matches for a sensed vehicle, that vehicle must be in some way first known to the recognition system, so vehicles to be identified are registered with the vehicle registration system. This registration process may be performed directly with a recognition system or indirectly by distribution of the registration information comprising registration profile, as it may be that certain vehicles are carried in the data stores of one or more vehicle registration systems, and so the registration information may be shared either through a distributed logical data store, or by being distributed to various vehicle recognition systems.

The registration may also occur as a special activity, e.g. as an enrollment or data entry, or as an automatic and/or transient registration, e.g. when a sensed vehicle is found to have no match and is then automatically registered. Example applications comprise automatic and/or transient registration for surveillance, city parking applications, zone parking applications, toll applications including toll revenue management applications, parking applications including parking revenue management applications, driveway access applications, parking drive through applications, and traffic analysis applications.

In the registration process, recordings are taken from the sensors. According to one embodiment of the present invention, the recordings are taken from a color camera and an infrared camera, and the resulting multiple metrics are transformed into a registration profile and may be associated with other information for that vehicle and stored in the vehicle recognition system data store.

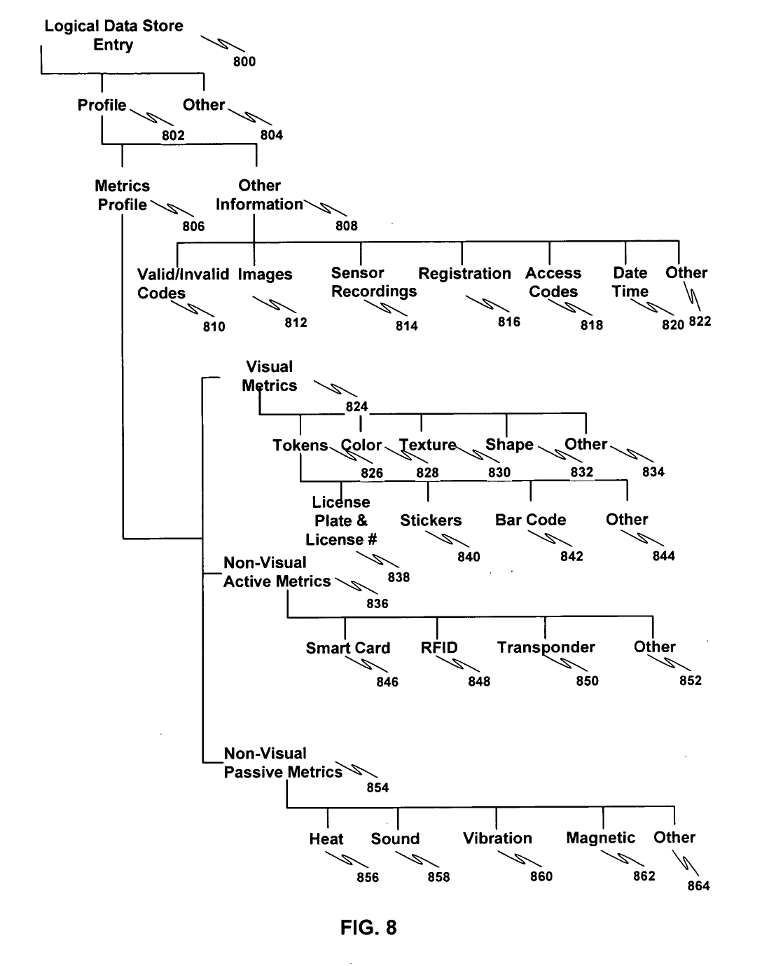

FIG. 8 is a schema diagram that illustrates a logical association of recorded and/or transformed sensor information for a vehicle profile, and associated with other vehicle information in accordance with one embodiment of the present invention. FIG. 8 is discussed in more detail below.

FIG. 6 also illustrates for the registration process, that it may comprise taking sets of sensor recordings from various directions or orientations of the vehicle, for example, front, rear, side, top, bottom, oblique, etc; and sets of sensor recordings for various lighting situations, for example, bright daylight, subdued daylight, yellow phosphorous, florescent, etc; and possibly other sets. According to one embodiment of the present invention, these multiple sets of sensor information may form a multiplex vehicle profile in the vehicle registration data store, comprising information characterizing one or more situations or conditions under which the recordings were obtained, for example, the type of lighting situation, the orientation of the vehicle, etc.

FIG. 6 also illustrates for the sensing of a vehicle, the characteristics of the sensing situation, such as type of lighting situation, the vehicle query profile may also comprise the orientation of the vehicle, etc.

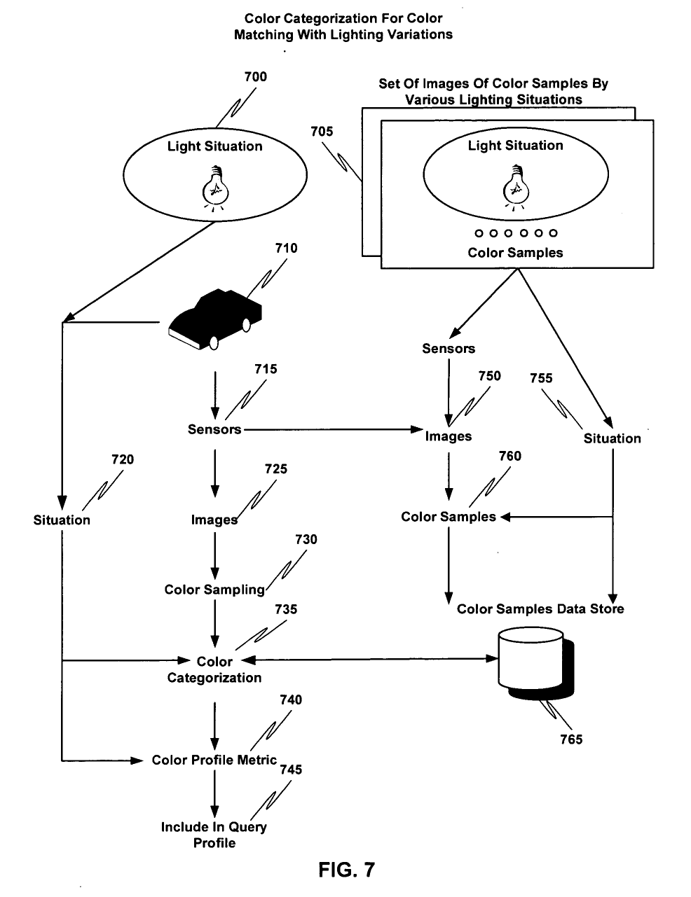

Turning now to FIG. 7, a block diagram that illustrates color sensing and matching in accordance with one embodiment of the present invention is presented. Color appears different in images depending on the lighting situation, for example, in the dark all colors appear black, and in very dim light most colors may appear grey. Intensity and spectrum characteristics of light also affect the recording of color, and so different light sources will affect the recordings. Images or recordings of the same color material, such as vehicle paint, made in different lighting conditions, e.g. by light source(s), time of day and year, weather, etc., will be different and not make exact matches when compared normally. FIG. 7 illustrates a process where color material sample recordings (750, 760) are made for various sets of known lighting situations 705, and stored with that associated information in a data store 765. When the recordings 725 of a sensed vehicle 710 are made, the lighting situation (700, 720) can also be included in the query profile (745). Also when the sensor recordings are transformed into a query profile for the sensed vehicle 710 the multiple color samples 760 under various lighting situations 755 can be used from the data store 765 to aid in categorizing the color of the vehicle (735), based on color sampling 730 of the recordings 725 and the light situations 720.

Turning now to FIG. 8, a schema diagram that illustrates metrics for use in vehicle identification in accordance with embodiments of the present invention is presented. Non-visual active metrics 836 is a type of metric where the vehicle actively generates, communicates, transmits, transacts, or displays an indication of its identity. This indication may be numeric or alphabetic or an alphanumeric or binary identifier or an association with a person's identifier, perhaps assisted by other information and/or security or cryptographic process or protocol. A vehicle may initiate to identify itself this way, or be prompted by a query station, or so identify itself by action of its driver or other occupant, or may routinely make this information available. Also information from tokens 826 may comprise such identifiers.

FIG. 8 also illustrates the inclusion of non-visual passive type of vehicle metrics 854 in a multi-metric vehicle profile of a vehicle recognition system, in accordance with one embodiment of the present invention. Non-visual passive metrics 854 is a type of metric where the vehicle does not actively generate, communicate, transmit, transact, or display information intended and/or designed for purposes of vehicle identification. Non-visual passive metrics 854 are a type of metric which may be investigated by a sensor, without cooperation from the vehicle and/or occupants. Typical examples of kinds of metrics of this type are illustrated in FIG. 8, comprising sensor recordings of relatively invariant vehicle metrics of heat 856, sound 858, vibration 860 and/or magnetic 862 qualities. Methods and apparatus for such non-visual passive types of vehicle identification are many and are generally known to one of ordinary skill in the art.

FIG. 8 also illustrates the inclusion of other information 808 with vehicle metrics in accordance with one embodiment of the present invention. According to one embodiment of the present invention, one or more codes 810 indicate whether the vehicle is registered for positive reasons and thus considered ‘valid’, or registered for negative reasons and thus considered ‘invalid’. Registered vehicles coded valid may be for example fleet vehicles in good standing of a corporation, that are registered for the purpose that they be able to enter certain corporate areas, or vehicles in good standing for membership in a parking area, etc. Registered vehicles coded invalid may be for example known to be lost or stolen, or wanted by the police, or considered dangerous, etc. Access codes information 818 may for example indicate what specific areas a valid vehicle has permission to enter, and where it does now have permission to enter, or for example may also indicate conditions of access, like time of day, etc. Date and time information 820 may include, for example, date and time of past events with a vehicle, data and time of past events with this entry in the registration data store, date and/or time of the beginning or expiration of a vehicles registration or of some aspects of it, etc. Registrant information 816 may comprise for example information about the owner of a vehicle, or a code for identifying the same vehicle or related information in an application system, etc.

According to one embodiment of the present invention, two visual metrics are used to recognize a vehicle. By way of example, an image 812 in the query profile (reference numeral 616 of FIG. 6) and an image 812 in the registration profile (reference numeral 636 of FIG. 6) may be used to recognize a vehicle.

The metrics illustrated in FIG. 8 are for the purposes of illustration and are not intended to be limiting in any way. Those of ordinary skill in the art will recognize that other metrics and other combinations of metrics may be used.

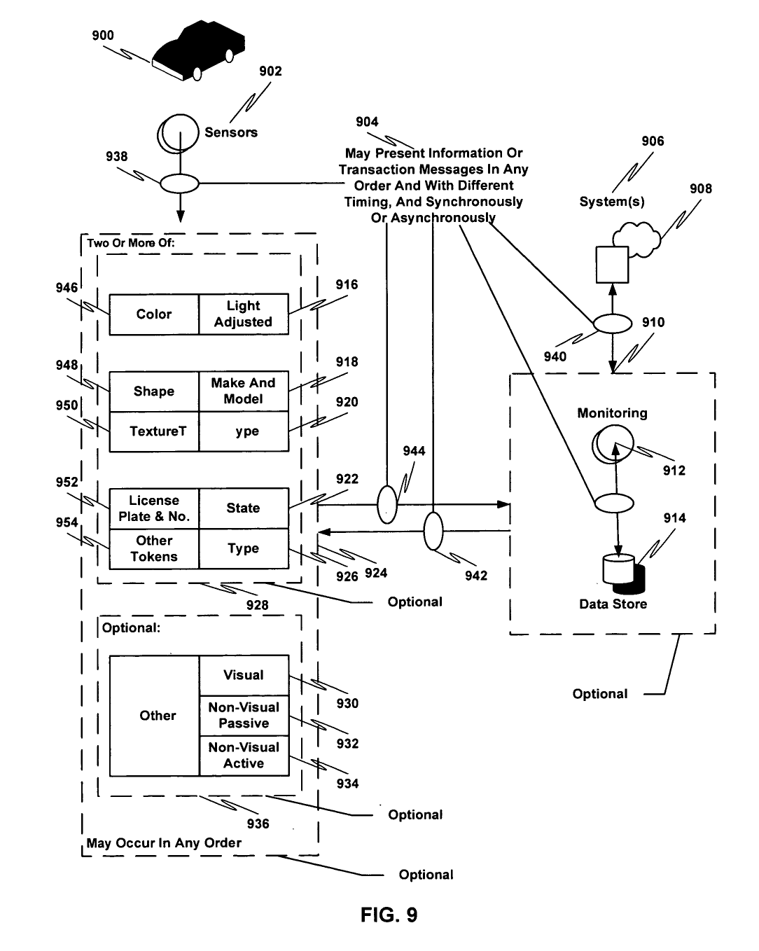

Turning now to FIG. 9, a block diagram that illustrates a method for vehicle recognition in accordance with one embodiment of the present invention is presented. The processes illustrated in FIG. 9 may be implemented in hardware, software, firmware, or a combination thereof. According to one embodiment of the present invention, the recognition of a vehicle is based at least in part identifying the vehicle by three basic visual metrics: color 946, shape 948, and visual token (952, 954). The color may comprise light adjusted color 916. The shape 948 is based at least in part on texture 950, and may be transformed to type 920 and/or make and model 918. Exemplary visual tokens comprise a license number 952, possibly augmented from license plate metrics comprising of state of origin 922 and type 926. The metrics may also comprise others more than these basic three, including one or more of other visual metrics 930, non-visual passive metrics 932, and/or non-visual active metrics 934.

FIG. 9 illustrates a feature of a one embodiment of the present invention, that generally the metrics may be processed in any order and in any timing, by configuration and/or control by the vehicle recognition system. Metric information may arrive from sensors in different timings and orders, depending, for example, on the method and apparatus of the particular sensors, and also on the communication method and timing from the sensors, etc. Also various metrics information may have varying processing requirements for transformation for the vehicle query profile, for example light adjusted color matching may involve more processing and take more time than un-adjusted color matching, etc. Also, query profile metrics may vary in the time effectiveness of the functions of matching them with registration profile metrics in the data store 914, and for example, portions of a distributed logical data store may have different performance characteristics, etc. For any of these reasons, it may be more effective for the purpose of any particular vehicle recognition system implementation to optimize performance characteristics of the system, for example including but not limited to, efficient use of computing resources, high volume throughput, fast response times, fast response times for in-part match responses, efficient search methods, etc. According to one embodiment of the present invention, the vehicle recognition system (1) processes metric information as it is available, (2) configures or controls the order and timing of various aspects of metric and/or profile processing for vehicle recognition to tune system characteristics as indicated above, or both.

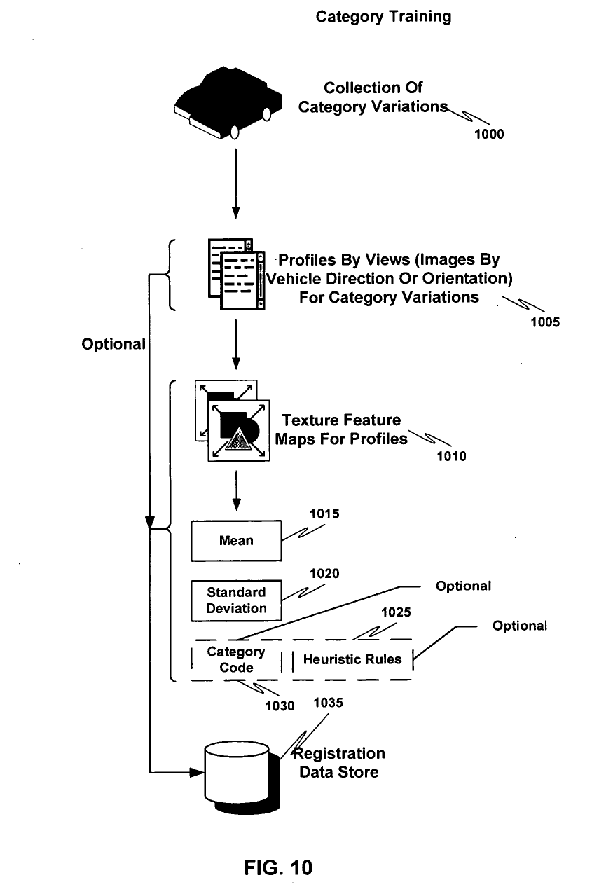

Turning now to FIG. 10, a block diagram that illustrates data relationships for category recognition of kinds of objects and/or vehicles in accordance with one embodiment of the present invention. This method uses the visual metric texture, of which basic methods are known by one of ordinary skill in the art. According to one embodiment of the present invention, the vehicle recognition system is adapted to recognize the category of a vehicle based at least in part on its associated query profile, for makes and models registered with the system. Registering a vehicle category with the system comprises taking sensor recordings and forming registration profiles for each of one or more vehicles demonstrating distinguishing features across the range of the make associated models. According to one embodiment of the present invention, for each vehicle of the collection 1000, profiles are gathered for one or more orientations of the vehicle and/or one or more lighting conditions, etc. (1005). According to one embodiment of the present invention, new profiles are added to a category collection from time to time as is found or hoped to improve the systems ability to recognize vehicles of that category.

Still referring to FIG. 10, for category registration, the vehicle profiles in the collection comprise texture information 1010, and for the set of texture data 1010, is calculated a statistical mean 1015 and standard deviation 1020. The vehicle profiles optionally comprise one or more category codes 1030 and one or more category heuristic rules 1025. The collection of vehicle profiles is coded to indicate their inclusion for application to a particular vehicle category. Where category codes 1030 can be, for example, of vehicle type (reference numeral 920 of FIG. 9, reference numeral 832 of FIG. 8), vehicle make and model (reference numeral 918 of FIG. 9), license plate state (reference numeral 922 of FIG. 9), license plate type (reference numeral 926 of FIG. 9), sticker type (reference numeral 954 of FIG. 9, reference numeral 840 of FIG. 8) and/or categories for other metrics. According to one embodiment of the present invention, the monitor functions match a vehicle query profile, using the mean 1015 and standard deviation 1020 information assisted by heuristic rules 1025 in ways known to one of ordinary skill in the art, to find a best fit category recognition in the category data store of the registration data store 1035 of a vehicle recognition system.

The method illustrated in FIG. 10 can be applied to clue information other than texture data 1010. By way of example, the vehicle profiles may comprise information such as vehicle type, license plate state of origin, license plate type, color, image, sound, magnetic properties, and the like.

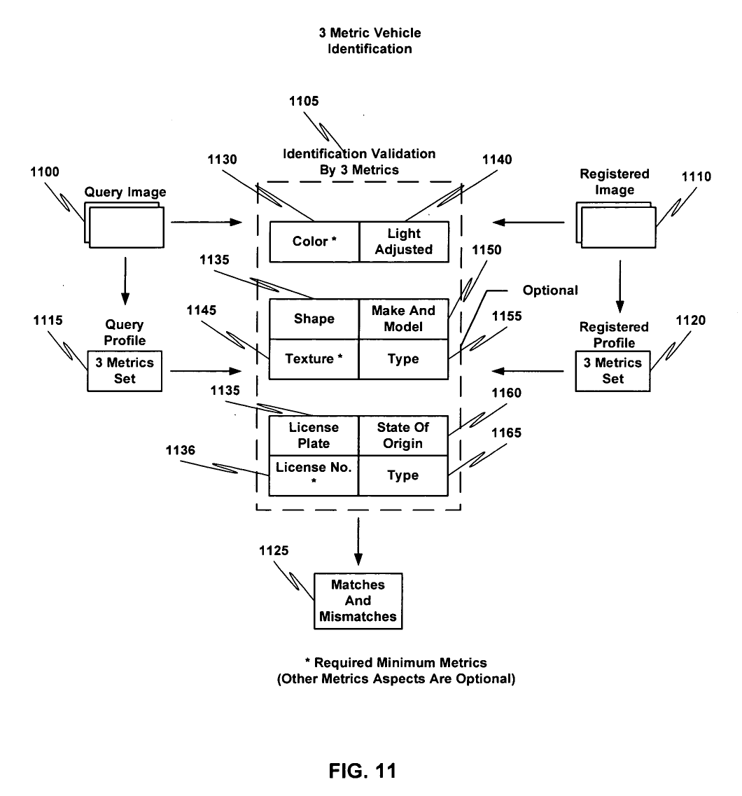

Turning now to FIG. 11, a block diagram that illustrates vehicle identification based at least in part on the vehicle's color, shape, and license number in accordance with one embodiment of the present invention is presented. FIG. 11 illustrates using three visual metrics (color 1130, shape 1135, and license number 1136). The color 1130 may comprise light adjusted color 1140. The shape 1135 may be based at least in part on texture 1145, and may be transformed to type 1155, make and model 1150, or both. The license number metric 1136 may be augmented by license plate metrics 1135 of state of origin 1160, type 1165, or both. A feature of this three-metric vehicle recognition 1105, and a kind of feature general to other options of metrics of a vehicle recognition system, is the ability to recognize mismatches of license number and vehicle, for example where the license plate may be on a vehicle other than the vehicle it was registered with. An additional feature of embodiments of the present invention is the ability to recognize such mismatches and/or possible mismatches among vehicle metrics 1115 of a query profile 1100 in relation to the registered vehicle profile metrics 1120. Mismatches may be presented so that a system, process or person may be informed and given the opportunity to recognize the vehicle, direct access control or other activity of, for example, an application system 436 for security and/or access control.

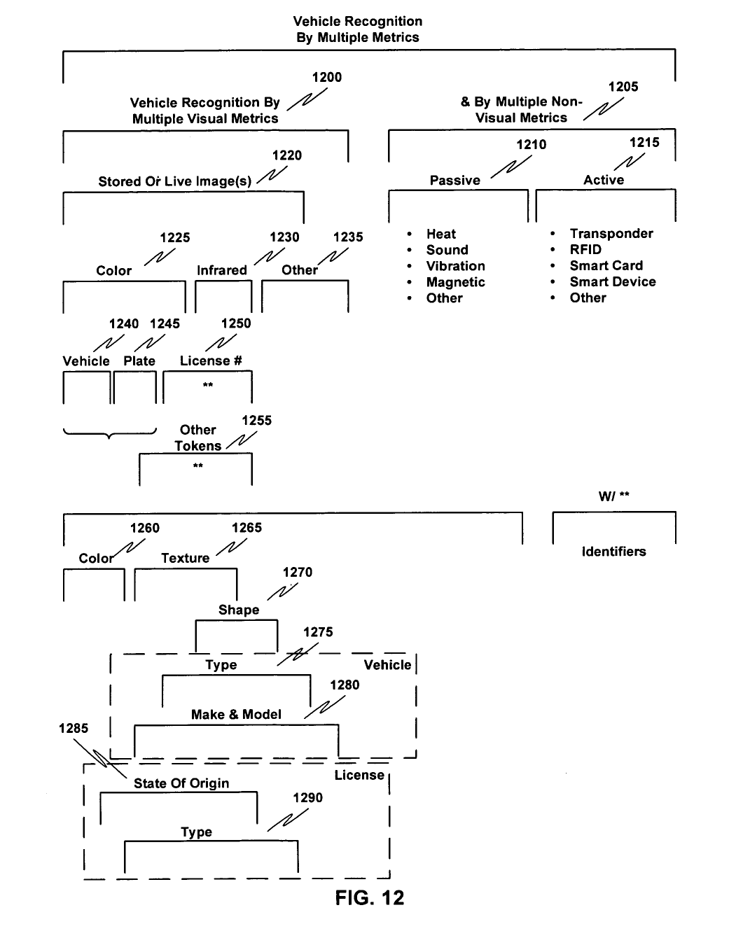

Turning now to FIG. 12, a schema diagram that illustrates a logical relationship of kinds of metrics in accordance with one embodiment of the present invention is presented. As shown in FIG. 12, the multiple metrics for vehicle recognition comprises visual metrics (1200) and non-visual metrics (1205). Non-visual metrics (1205) comprise passive (1210) and active (1215) types of metrics. Visual metrics 1200 comprise stored or live images 1220 (analog or digital, still or video). Images 1220 comprise color images 1225 and infrared 1230 and other 1235. The vehicle 1240 and license plate 1245 query metrics are derived from color images 1225, and the license number 1250 is derived from either or both of color 1225 and/or infrared images 1230 (as is the case with other visual tokens 1235). Any of license numbers 1250, identifier information from other visual tokens 1255, and/or identifier information from non-visual active metrics 1215 can be identifiers for vehicle identification and/or for specific or potential matches and/or mismatches with other vehicle metrics, including mismatches with any other identifiers. Color 1260 and texture 1256 metrics are also derived from the images 1220.

Shape 1270 may be derived from texture 1265 and/or from the images 1220. Type 1275, for example, van or truck or SUV, may be derived from texture 1265, shape 1270, and/or images 1220. Make and model 1280 may be derived from texture 1265, type 1275, shape 1270, and/or images 1220. License plate state of origin 1285 may be derived from texture 1265, type 1275, shape 1270, and/or images 1220 in a way analogous to the process described above with respect to FIG. 10. License plate type 1290 may be further derived from texture 1265, type 1275, shape 1270, license plate state of origin 1285, and/or images 1220, also as described above with respect to FIG. 10. Exemplary license plate types comprise “handicapped”, “commercial”, “personalized”, “state”, and “diplomat” types.

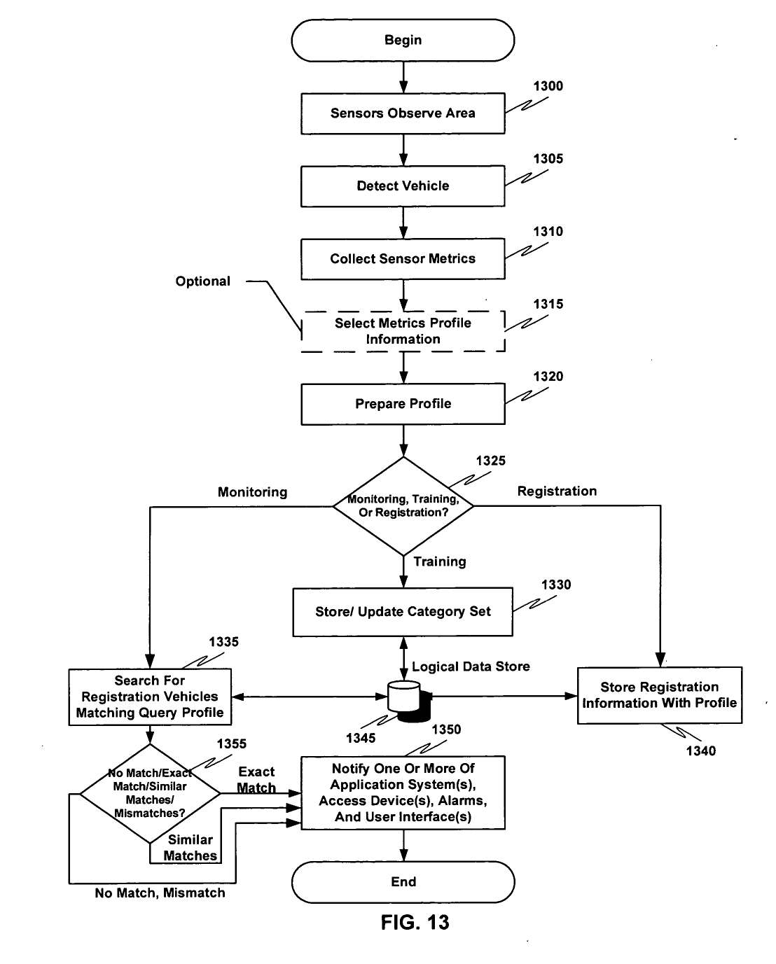

Turning now to FIG. 13, a flow diagram that illustrates a method for vehicle recognition in accordance with one embodiment of the present invention is presented. The processes illustrated in FIG. 7 may be implemented in hardware, software, firmware, or a combination thereof. At 1300, one or more sensors observe an area. At 1305, a vehicle is detected. At 1310, sensor metrics are collected. At 1315, metrics profile information is optionally selected. At 1320, a profile is prepared. The profile comprises one or more of (1) at least some of the sensor metrics, and (2) a result of analyzing at least some of the sensor metrics. At 1325, a determination is made regarding whether the current mode is registration mode, training mode, or monitoring mode. If the current mode is registration mode, at 1340 the registration information is stored in the logical data store 1345 with the profile. If the current mode is monitoring mode, at 1335 the logical data store 1345 is searched for registration vehicles matching the query profile. If the current mode is training mode, at 1330 the category set is stored or updated in the logical data store 1345. At 1355, a determination is made regarding whether the search performed at 1335 found no match, an exact match, a mismatch, or one or more similar matches. At 1350, one or more application system(s), access device(s), alarm(s), and user interface(s) are notified of the match results, and optionally the match result information is provided. Provided information may be used by any of systems, processes, and/or persons so as to inform and give the opportunity to recognize the vehicle, direct access control or other activity of, for example, an application system 436 for security and/or access control.

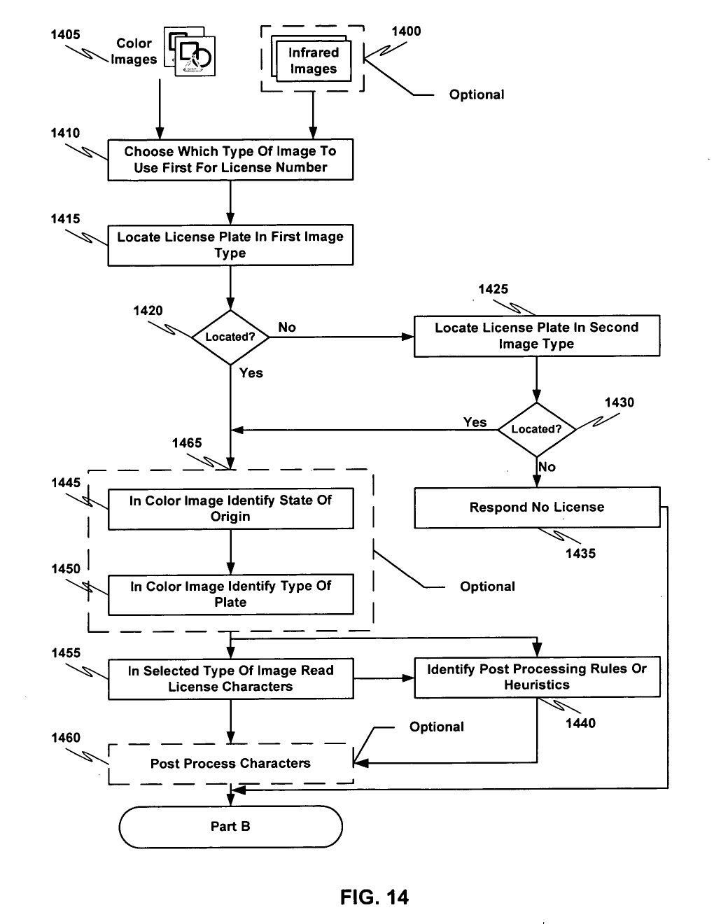

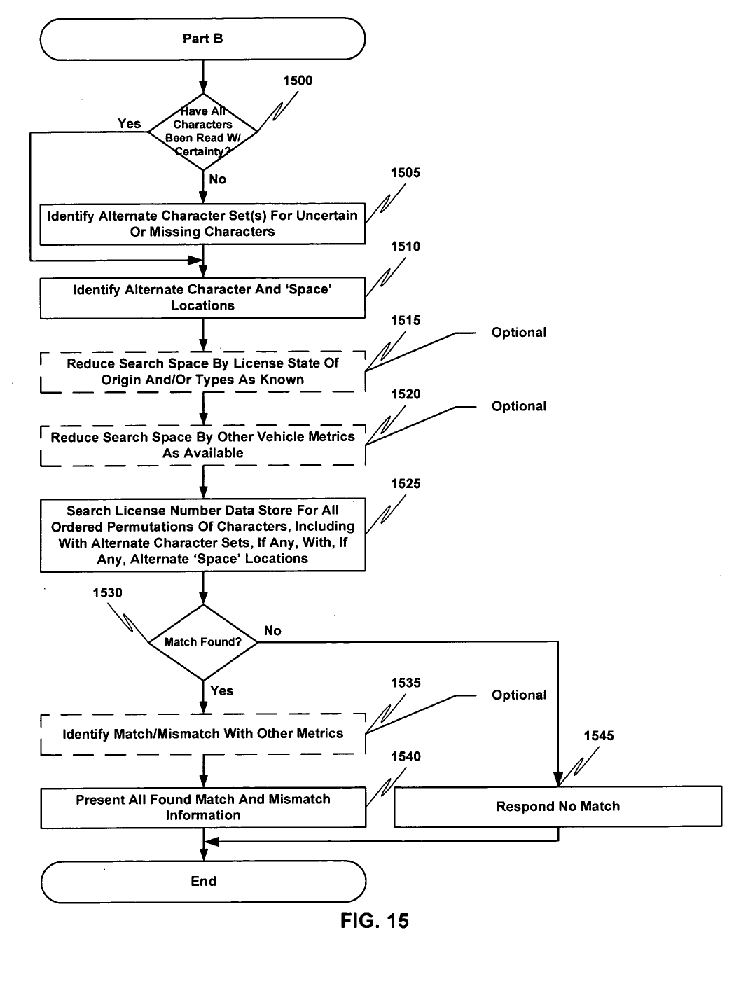

FIGS. 14 and 15 are flow diagrams that illustrate a method for license plate and license number metric processing in accordance with one embodiment of the present invention. FIG. 15 is a continuation of FIG. 14. The processes illustrated in FIGS. 14 and 15 may be implemented in hardware, software, firmware, or a combination thereof.

Turning now to FIG. 14, at 1410 a determination is made regarding whether to first use one or more color images 1405 or one or more infrared images 1400 to identify a license number. At 1415 an attempt is made to locate the license plate in the image type selected at 1410. If the license plate is not located, at 1425 an attempt is made to locate the license plate in the image type not selected at 1410. If the license plate is not located at 1430, an indication that no license was found is made at 1435. If the license plate is located in a color image at 1420, the state of origin and the plate type are optionally identified in the color image at reference numerals 1445 and 1450, respectively. At 1455, license characters are read in the selected image type. At 1440, one or more post-processing rules or heuristics are identified. Processes 1455 and 1440 may be performed serially or in parallel, and in any order with respect to each other. At 1460, post-processing is optionally performed on the license characters to improve their readability and certainty and/or project alternatives for occluded or otherwise uncertain characters.

Turning now to FIG. 15, a determination is made regarding whether all the characters have been read with certainty. If all the characters have not been read with certainty, at 1505 one or more alternate character sets for uncertain or missing characters are identified. The inability to read a character with certainty may be due to partial occlusion of the characters in the image, or the font characteristics of a character. For example, an ‘A’ may not appear clearly distinct from the ‘8’, ‘B’, or ‘4’ characters. An alternate character set for a particular character comprises one or more other characters that may be substituted for the particular character for the purpose of matching. According to one embodiment of the present invention, the alternate character set for a particular character comprises one or more other characters that have characteristics similar to the particular character. In the present example, the alternate character set (‘8’, ‘B’, ‘4’) may be identified for the character ‘A’. As a further example, the alternate character set for the ‘1’ (number one) character may comprise lower case letter ‘l’, upper case letter ‘L’, lower case letter ‘I’, and upper case letter ‘I’. Those of ordinary skill in the art will recognize that many other character sets for various characters are possible.

Still referring to FIG. 15, at 1510 alternate character and ‘Space’ locations are identified. The inability to read a character with certainty may be due to image angle or resolution. For example, it may be unclear whether the characters read are ‘123’, ‘1 23’, or ‘12 3’, or in fact in combination with alternate character sets is ‘L23’, ‘L 23’, or ‘L2 3’. Or the uncertainty may be with respect to whether the spacing between characters is a fractional width, e.g. ½ character width or 3/4 character width. Thus an alternate set of size and location of spacing is identified.

Still referring to FIG. 15, at 1515 the search space is optionally reduced by license state of origin, license type, or both. At 1520, the search space is optionally reduced by one or more other metrics. At 1525, the license number data store is searched for all ordered permutations of characters, including those with alternate character sets, if any, with, if any, alternate ‘Space’ locations. For example, based on the above examples, for the case of ‘A123’, the permutations are ‘A123’, 8123’, ‘B123’, ‘4123’, and further ‘A 123’, ‘A1 23’, ‘AL23’, ‘A12 3’, etc. as follows logically are searched for matches. At 1530, a determination is made regarding whether a match was found. If a match was not found, an indication that no match was found is made at 1545. If a match or matches were found, matches or mismatches with other metrics are optionally identified at 1535.

According to one embodiment of the present invention, identifying matches or mismatches comprises comparing vehicle make and/or vehicle model information obtained from a license number metric with other visual metrics. By way of example, if a license number metric is “ABC DEFG” and a data store indicates license metric “ABC DEFG” is associated with a 1994 Blue Ford Taurus”, visual metrics that indicate a different make, model, or color of vehicle would result in a mismatch. Similarly, if a non-visual active metric (such as a smart card, RFID, transponder, or the like) indicated a different vehicle, a mismatch would be indicated.

Still referring to FIG. 15, at 1540 all found match and mismatch information is presented. Presented information may be used by any of systems, processes and/or persons so as to inform and give the opportunity to recognize the vehicle, direct access control or other activity of, for example, an application system 436 for security and/or access control.

The process described with respect to FIGS. 14 and 15 is for the purpose of illustration and is not intended to be limiting in any way. The steps of the process can be processed in any logical order. Additionally, other metrics including identifiers can be used.

While embodiments of the present invention have been described with respect to vehicle recognition, embodiments of the present invention apply more generally to object recognition. By way of example, embodiments of the present invention apply to objects such as shipping containers being transported from one location to another, i.e. to prevent or monitor the movement of containers that match an object profile.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for vehicle recognition, the method comprising:
receiving a plurality of metrics from one or more vehicle sensors;
analyzing said plurality of metrics to create a multi-metric vehicle identification profile comprising at least two of said plurality of metrics, at least one result of said analyzing, or both; and
matching said multi-metric vehicle identification profile against a plurality of stored vehicle sensor recordings.

2. The method of claim 1 wherein said first sensor comprises a color video camera.

3. The method of claim 2, further comprising obtaining color, shape, and license number metrics from said color video camera.

4. The method of claim 2 wherein said second sensor comprises an infrared video camera.

5. The method of claim 1 wherein said plurality of metrics comprises:
vehicle color; and
vehicle license number.

6. The method of claim 5 wherein said plurality of metrics further comprises:
vehicle shape.

7. The method of claim 1, further comprising determining whether to restrict or grant access to one or more facilities, one or more services, or both, based at least in part on whether said at least one of said plurality of stored vehicle sensor recordings matches said multi-metric vehicle identification profile.

8. The method of claim 1, further comprising:
if at least one of said plurality of stored vehicle sensor recordings matches said multi-metric vehicle identification profile, presenting said at least one of said plurality of stored vehicle sensor recordings.

9. The method of claim 8 wherein said at least one of said plurality of stored sensor recordings comprises at least one video image.

10. The method of claim 1 wherein said one or more vehicle sensors comprises one vehicle sensor.

11. The method of claim 1 wherein said one or more vehicle sensors comprises a color video camera and at least one other vehicle sensor.

12. The method of claim 1 wherein said multi-metric vehicle identification profile comprises information characterizing one or more conditions under which said plurality of metrics was obtained.

13. The method of claim 1 wherein at least one of said one or more vehicle sensors comprises a stationary vehicle sensor.

14. The method of claim 1 wherein at least one of said one or more vehicle sensors comprises a mobile vehicle sensor.

15. The method of claim 1 wherein said receiving further comprises receiving said plurality of metrics in real-time.

16. The method of claim 1 wherein said receiving further comprises receiving a recording of said plurality of metrics in real-time.

17. The method of claim 1 wherein said receiving further comprises receiving a recording of said plurality of metrics.

18. The method of claim 1 wherein said receiving further comprises receiving said plurality of metrics according to one or more schedules; and
matching said multi-metric vehicle identification profile against a plurality of stored vehicle sensor recordings.

19. The method of claim 1 wherein said matching further comprises substituting or replacing at least one character in said multi-metric vehicle identification profile with at least one other character.

20. The method of claim 19 wherein said matching further comprises using one or more alternate character set of at least one character in said multi-metric vehicle identification profile.

21. The method of claim 19 wherein said matching further comprises using one or more alternate space sizes, locations, or both, for a license number in said multi-metric vehicle identification profile.

22. A program storage device readable by a machine, embodying a program of instructions executable by the machine to perform a method for vehicle recognition, the method comprising:
receiving a plurality of metrics from one or more vehicle sensors;
analyzing said plurality of metrics to create a multi-metric vehicle identification profile comprising at least two of said plurality of metrics, at least one result of said analyzing, or both; and
matching said multi-metric vehicle identification profile against a plurality of stored vehicle sensor recordings.

23. The program storage device of claim 22 wherein said first sensor comprises a color video camera.

24. The program storage device of claim 23, said method further comprising obtaining color, shape, and license number metrics from said color video camera.

25. The program storage device of claim 23 wherein said second sensor comprises an infrared video camera.

26. The program storage device of claim 22 wherein said plurality of metrics comprises:
vehicle color; and
vehicle license number.

27. The program storage device of claim 26 wherein said plurality of metrics further comprises:
vehicle shape.

28. The program storage device of claim 22, said method further comprising determining whether to restrict or grant access to one or more facilities, one or more services, or both, based at least in part on whether said at least one of said plurality of stored vehicle sensor recordings matches said multi-metric vehicle identification profile.

29. The program storage device of claim 22, said method further comprising:
if at least one of said plurality of stored vehicle sensor recordings matches said multi-metric vehicle identification profile, presenting said at least one of said plurality of stored vehicle sensor recordings.

30. The program storage device of claim 29 wherein said at least one of said plurality of stored sensor recordings comprises at least one video image.

31. The program storage device of claim 22 wherein said one or more vehicle sensors comprises one vehicle sensor.

32. The program storage device of claim 22 wherein said one or more vehicle sensors comprises a color video camera and at least one other vehicle sensor.

33. The program storage device of claim 22 wherein said multi-metric vehicle identification profile comprises information characterizing one or more conditions under which said plurality of metrics was obtained.

34. The program storage device of claim 22 wherein at least one of said one or more vehicle sensors comprises a stationary vehicle sensor.

35. The program storage device of claim 22 wherein at least one of said one or more vehicle sensors comprises a mobile vehicle sensor.

36. The program storage device of claim 22 wherein said receiving further comprises receiving said plurality of metrics in real-time.

37. The program storage device of claim 22 wherein said receiving further comprises receiving a recording of said plurality of metrics in real-time.

38. The program storage device of claim 22 wherein said receiving further comprises receiving a recording of said plurality of metrics.

39. The program storage device of claim 22 wherein said receiving further comprises receiving said plurality of metrics according to one or more schedules; and
matching said multi-metric vehicle identification profile against a plurality of stored vehicle sensor recordings.

40. The program storage device of claim 22 wherein said matching further comprises substituting or replacing at least one character in said multi-metric vehicle identification profile with at least one other character.

41. The program storage device of claim 40 wherein said matching further comprises using one or more alternate character set of at least one character in said multi-metric vehicle identification profile.

42. The program storage device of claim 40 wherein said matching further comprises using one or more alternate space sizes, locations, or both, for a license number in said multi-metric vehicle identification profile.

43. An apparatus for vehicle recognition, the apparatus comprising:
receiving a plurality of metrics from one or more vehicle sensors;
means for analyzing said plurality of metrics to create a multi-metric vehicle identification profile comprising at least two of said plurality of metrics, at least one result of said analyzing, or both; and
means for matching said multi-metric vehicle identification profile against a plurality of stored vehicle sensor recordings.

44. The apparatus of claim 43 wherein said first sensor comprises a color video camera.

45. The apparatus of claim 44, further comprising means for obtaining color, shape, and license number metrics from said color video camera.

46. The apparatus of claim 44 wherein said second sensor comprises an infrared video camera.

47. The apparatus of claim 43 wherein said plurality of metrics comprises:
vehicle color; and
vehicle license number.

48. The apparatus of claim 47 wherein said plurality of metrics further comprises:
vehicle shape.

49. The apparatus of claim 43, further comprising means for determining whether to restrict or grant access to one or more facilities, one or more services, or both, based at least in part on whether said at least one of said plurality of stored vehicle sensor recordings matches said multi-metric vehicle identification profile.

50. The apparatus of claim 43, further comprising:
means for if at least one of said plurality of stored vehicle sensor recordings matches said multi-metric vehicle identification profile, presenting said at least one of said plurality of stored vehicle sensor recordings.

51. The apparatus of claim 50 wherein said at least one of said plurality of stored sensor recordings comprises at least one video image.

52. The apparatus of claim 43 wherein said one or more vehicle sensors comprises one vehicle sensor.

53. The apparatus of claim 43 wherein said one or more vehicle sensors comprises a color video camera and at least one other vehicle sensor.

54. The apparatus of claim 43 wherein said multi-metric vehicle identification profile comprises information characterizing one or more conditions under which said plurality of metrics was obtained.

55. The apparatus of claim 43 wherein at least one of said one or more vehicle sensors comprises a stationary vehicle sensor.

56. The apparatus of claim 43 wherein at least one of said one or more vehicle sensors comprises a mobile vehicle sensor.

57. The apparatus of claim 43 wherein said receiving further comprises receiving said plurality of metrics in real-time.

58. The apparatus of claim 43 wherein said receiving further comprises receiving a recording of said plurality of metrics in real-time.

59. The apparatus of claim 43 wherein said receiving further comprises receiving a recording of said plurality of metrics.

60. The apparatus of claim 43 wherein said receiving further comprises receiving said plurality of metrics according to one or more schedules; and
matching said multi-metric vehicle identification profile against a plurality of stored vehicle sensor recordings.

61. The apparatus of claim 43 wherein said matching further comprises substituting or replacing at least one character in said multi-metric vehicle identification profile with at least one other character.

62. The apparatus of claim 61 wherein said matching further comprises using one or more alternate character set of at least one character in said multi-metric vehicle identification profile.

63. The apparatus of claim 61 wherein said matching further comprises using one or more alternate space sizes, locations, or both, for a license number in said multi-metric vehicle identification profile.

64. An apparatus for vehicle recognition, the apparatus comprising:
one or more data stores comprising a plurality of stored vehicle sensor recordings; and
one or more processors adapted to:
receive a plurality of metrics from one or more vehicle sensors;
analyze said plurality of metrics to create a multi-metric vehicle identification profile comprising at least two of said plurality of metrics, at least one result of said analyzing, or both; and
match said multi-metric vehicle identification profile against said plurality of stored vehicle sensor recordings.

65. The apparatus of claim 64 wherein said first sensor comprises a color video camera.

66. The apparatus of claim 65 wherein said one or more processors are further adapted to obtain color, shape, and license number metrics from said color video camera.

67. The apparatus of claim 65 wherein said second sensor comprises an infrared video camera.

68. The apparatus of claim 64 wherein said plurality of metrics comprises:
vehicle color; and
vehicle license number.

69. The apparatus of claim 68 wherein said plurality of metrics further comprises:
vehicle shape.

70. The apparatus of claim 64 wherein said one or more processors are further adapted to determine whether to restrict or grant access to one or more facilities, one or more services, or both, based at least in part on whether said at least one of said plurality of stored vehicle sensor recordings matches said multi-metric vehicle identification profile.

71. The apparatus of claim 64 wherein said one or more processors are further adapted to, if at least one of said plurality of stored vehicle sensor recordings matches said multi-metric vehicle identification profile, present said at least one of said plurality of stored vehicle sensor recordings.

72. The apparatus of claim 71 wherein said at least one of said plurality of stored sensor recordings comprises at least one video image.

73. The apparatus of claim 64 wherein said one or more vehicle sensors comprises one vehicle sensor.

74. The apparatus of claim 64 wherein said one or more vehicle sensors comprises a color video camera and at least one other vehicle sensor.

75. The apparatus of claim 64 wherein said multi-metric vehicle identification profile comprises information characterizing one or more conditions under which said plurality of metrics was obtained.

76. The apparatus of claim 64 wherein at least one of said one or more vehicle sensors comprises a stationary vehicle sensor.

77. The apparatus of claim 64 wherein at least one of said one or more vehicle sensors comprises a mobile vehicle sensor.

78. The apparatus of claim 64 wherein said one or more processors are further adapted to receive said plurality of metrics in real-time.

79. The apparatus of claim 64 wherein said one or more processors are further adapted to receive a recording of said plurality of metrics in real-time.

80. The apparatus of claim 64 wherein said one or more processors are further adapted to receive a recording of said plurality of metrics.

81. The apparatus of claim 64 wherein said one or more processors are further adapted to receive said plurality of metrics according to one or more schedules; and
match said multi-metric vehicle identification profile against a plurality of stored vehicle sensor recordings.

82. The apparatus of claim 64 wherein said one or more processors are further adapted to substitute or replace at least one character in said multi-metric vehicle identification profile with at least one other character.

83. The apparatus of claim 82 wherein said one or more processors are further adapted to use one or more alternate character set of at least one character in said multi-metric vehicle identification profile.

84. The apparatus of claim 82 wherein said one or more processors are further adapted to use one or more alternate space sizes, locations, or both, for a license number in said multi-metric vehicle identification profile.

85. A method for object recognition, the method comprising:
receiving a plurality of metrics from one or more object sensors;
analyzing said plurality of metrics to create an object identification profile comprising at least two of said plurality of metrics, at least one result of said analyzing, or both; and
matching said object identification profile against a plurality of stored object sensor recordings.

86. A program storage device readable by a machine, embodying a program of instructions executable by the machine to perform a method for object recognition, the method comprising:
receiving a plurality of metrics from one or more object sensors;
analyzing said plurality of metrics to create a multi-metric object identification profile comprising at least two of said plurality of metrics, at least one result of said analyzing, or both; and
matching said object identification profile against a plurality of stored object sensor recordings.

87. An apparatus for object recognition, the apparatus comprising:
means for receiving a plurality of metrics from one or more object sensors;
means for analyzing said plurality of metrics to create a multi-metric object identification profile comprising at least two of said plurality of metrics, at least one result of said analyzing, or both; and
means for matching said object identification profile against a plurality of stored object sensor recordings.

88. An apparatus for object recognition, the apparatus comprising:
one or more data store comprising a plurality of stored object sensor recordings; and
one or more processors adapted to:
receive a plurality of metrics from one or more object sensors;
analyze said plurality of metrics to create a multi-metric object identification profile comprising at least two of said plurality of metrics, at least one result of said analyzing, or both; and
match said object identification profile against said plurality of stored object sensor recordings.

89. A method for identifying one or more mismatches between a plurality of vehicle metrics, the method comprising:
receiving a plurality of metrics from one or more vehicle sensors;
analyzing said plurality of metrics to create a multi-metric vehicle identification profile comprising at least two of said plurality of metrics, at least one result of said analyzing, or both;
obtaining from a vehicle registration data store, one or more vehicle registration profiles corresponding to said at least one metric; and
indicating a mismatch if at least part of said multi-metric vehicle identification profile does not match said vehicle registration profile.

90. A program storage device readable by a machine, embodying a program of instructions executable by the machine to perform a method for identifying one or more mismatches between a plurality of vehicle metrics, the method comprising:
receiving a plurality of metrics from one or more vehicle sensors;
analyzing said plurality of metrics to create a multi-metric vehicle identification profile comprising at least two of said plurality of metrics, at least one result of said analyzing, or both;
obtaining from a vehicle registration data store, one or more vehicle registration profiles corresponding to said at least one metric; and
indicating a mismatch if at least part of said multi-metric vehicle identification profile does not match said vehicle registration profile.

91. An apparatus for identifying one or more mismatches between a plurality of vehicle metrics, the apparatus comprising:
means for receiving a plurality of metrics from one or more vehicle sensors;
means for analyzing said plurality of metrics to create a multi-metric vehicle identification profile comprising at least two of said plurality of metrics, at least one result of said analyzing, or both;
means for obtaining from a vehicle registration data store, one or more vehicle registration profiles corresponding to said at least one metric; and
means for indicating a mismatch if at least part of said multi-metric vehicle identification profile does not match said vehicle registration profile.

92. An apparatus for identifying one or more mismatches between a plurality of vehicle metrics, the apparatus comprising:
a registration data store comprising one or more vehicle registration profiles; and
one or more processors adapted to:
receive a plurality of metrics from one or more vehicle sensors;
analyze said plurality of metrics to create a multi-metric vehicle identification profile comprising at least two of said plurality of metrics, at least one result of said analyzing, or both;
obtain from a vehicle registration data store, one or more vehicle registration profiles in said registration data store corresponding to said at least one metric; and
indicate a mismatch if at least part of said multi-metric vehicle identification profile does not match said vehicle registration profile.

93. A method for monitoring vehicles based on vehicle type, the method comprising:
creating one or more registration profiles for at least one orientation of each of one or more vehicles categorized at least by orientation, said one or more registration profiles based at least in part on a plurality of metrics received from one or more vehicle sensors, said one or more vehicle registration profiles comprising texture information; and
matching a vehicle query profile against said one or more multi-metric vehicle identification profiles.

94. The method of claim 93 wherein said one or more vehicle information profiles are further categorized by at least vehicle make and model.

95. The method of claim 93 wherein said one or more vehicle information profiles are further categorized by at least license plate state of origin.

96. The method of claim 93 wherein said one or more vehicle information profiles are further categorized by at least license plate type.

97. The method of claim 93 wherein said one or more vehicle information profiles comprise one or more category codes and one or more category heuristic rules.

98. A program storage device readable by a machine, embodying a program of instructions executable by the machine to perform a method for monitoring vehicles based on vehicle type, the method comprising:
creating one or more registration profiles for at least one orientation of each of one or more vehicles categorized at least by orientation, said one or more registration profiles based at least in part on a plurality of metrics received from one or more vehicle sensors, said one or more vehicle registration profiles comprising texture information; and
matching a vehicle query profile against said one or more multi-metric vehicle identification profiles.

99. The program storage device of claim 98 wherein said one or more vehicle information profiles are further categorized by at least vehicle make and model.

100. The program storage device of claim 98 wherein said one or more vehicle information profiles are further categorized by at least license plate state of origin.

101. The program storage device of claim 98 wherein said one or more vehicle information profiles are further categorized by at least license plate type.

102. The program storage device of claim 98 wherein said one or more vehicle information profiles comprise one or more category codes and one or more category heuristic rules.

103. An apparatus for monitoring vehicles based on vehicle type, the apparatus comprising:
means for creating one or more registration profiles for at least one orientation of each of one or more vehicles categorized at least by orientation, said one or more registration profiles based at least in part on a plurality of metrics received from one or more vehicle sensors, said one or more vehicle registration profiles comprising texture information; and
means for matching a vehicle query profile against said one or more multi-metric vehicle identification profiles.

104. The apparatus of claim 103 wherein said one or more vehicle information profiles are further categorized by at least vehicle make and model.

105. The apparatus of claim 103 wherein said one or more vehicle information profiles are further categorized by at least license plate state of origin.

106. The apparatus of claim 103 wherein said one or more vehicle information profiles are further categorized by at least license plate type.

107. The apparatus of claim 103 wherein said one or more vehicle information profiles comprise one or more category codes and one or more category heuristic rules.

108. An apparatus for monitoring vehicles based on vehicle type, the apparatus comprising:
one or more data stores comprising one or more registration profiles; and
one or more processors adapted to:
create one or more registration profiles for at least one orientation of each of one or more vehicles categorized at least by orientation, said one or more registration profiles based at least in part on a plurality of metrics received from one or more vehicle sensors, said one or more vehicle registration profiles comprising texture information; and
match a vehicle query profile against said one or more multi-metric vehicle identification profiles.

109. The apparatus of claim 108 wherein said one or more vehicle information profiles are further categorized by at least vehicle make and model.

110. The apparatus of claim 108 wherein said one or more vehicle information profiles are further categorized by at least license plate state of origin.

111. The apparatus of claim 108 wherein said one or more vehicle information profiles are further categorized by at least license plate type.

112. The apparatus of claim 108 wherein said one or more vehicle information profiles comprise one or more category codes and one or category model heuristic rules.

113. A method for vehicle recognition, the method comprising:
receiving a first plurality of metrics from one or more vehicle sensors;
analyzing said first plurality of metrics to create a first multi-metric vehicle identification profile comprising at least two of said plurality of metrics, at least one result of said analyzing said first plurality of metrics, or both; and
storing said first multi-metric vehicle identification profile in a vehicle registration data store;
receiving a second plurality of metrics from said one or more vehicle sensors;
analyzing said second plurality of metrics to create a second multi-metric vehicle identification profile comprising at least two of said plurality of metrics, at least one result of said analyzing said first plurality of metrics, or both; and
matching said second multi-metric vehicle identification profile against at least one multi-metric vehicle identification profile in said vehicle registration data store.

114. The method of claim 113 wherein said storing further comprising storing said first multi-metric vehicle identification profile in said vehicle registration data store if said multi-metric vehicle identification profile is absent from said vehicle registration data store.

115. The method of claim 113, further comprising controlling the presence of or access for one or more vehicles in their movement from one area to another.

116. A method for license plate recognition for license plates having non-uniform character size and spacing, the method comprising:
receiving a plurality of metrics from one or more vehicle sensors;
analyzing said plurality of metrics to create a multi-metric vehicle identification profile comprising at least two of said plurality of metrics, at least one result of said analyzing, or both; and
matching said multi-metric vehicle identification profile against a plurality of stored vehicle sensor recordings.

117. A method for vehicle color characterization, the method comprising:
storing in a data store one or more vehicle color material sample image recordings and for each of said color material sample image recordings, an indication of the lighting conditions under which said color material sample image recordings were made;
receiving an image recording corresponding to a sensed vehicle and an indication of the lighting conditions under which said image recording was made; and
matching said image recording to one or more of said vehicle color material sample image recordings in said data store based at least in part on said indication of the lighting conditions under which said image recording was made.

118. A system for vehicle recognition, the system comprising:
one or more vehicle sensors adapted to sense one or more vehicle metrics; and
a recognition processing system communicatively coupled to said one or more vehicle sensors, said recognition processing system adapted to:
receive a plurality of metrics from said one or more vehicle sensors;
analyze said plurality of metrics to create a multi-metric vehicle identification profile comprising at least two of said plurality of metrics, at least one result of said analyzing, or both; and
match said multi-metric vehicle identification profile against a plurality of stored vehicle sensor recordings.

119. The system of claim 118, further comprising:
one or more application systems communicatively coupled to said recognition processing system, said one or more application systems adapted to use the result of said match to perform a process.

120. An apparatus for vehicle recognition, the apparatus comprising:
one or more vehicle sensors adapted to sense one or more vehicle metrics; and
a recognition processing system communicatively coupled to said one or more vehicle sensors, said recognition processing system adapted to:
receive a plurality of metrics from one or more vehicle sensors;
analyze said plurality of metrics to create a multi-metric vehicle identification profile comprising at least two of said plurality of metrics, at least one result of said analyzing, or both; and
match said multi-metric vehicle identification profile against a plurality of stored vehicle sensor recordings.

121. The apparatus of claim 120, further comprising:
one or more application systems communicatively coupled to said recognition processing system, said one or more application systems adapted to use the result of said match to perform a process.

122. The apparatus of claim 121 wherein said apparatus comprises a flashlight.

123. The apparatus of claim 121 wherein said apparatus comprises a camera.

124. A method for vehicle application system management, comprising:
receiving an indication of whether a vehicle recognition system recognized a vehicle, said vehicle recognition system adapted to:
receive a plurality of metrics from one or more vehicle sensors;
analyze said plurality of metrics to create a multi-metric vehicle identification profile comprising at least two of said plurality of metrics, at least one result of said analyzing, or both; and
match said multi-metric vehicle identification profile against a plurality of stored vehicle sensor recordings; and
making one or more determinations regarding the presence of or access for said vehicle in the movement of said vehicle from one area to another, or regarding access to one or more services.

125. The method of claim 124 wherein said area comprises at least one of a parking area, a driveway, a road, a toll road, a railway, a cableway, open water, a waterway, an airway, a space way, a dock, a marina, an airport, a space port, a trail, a path, a bridge, a lock, a gateway, a building, a ferrie, a park, a field, and an off-road area.

126. The method of claim 124 wherein said one or more services comprises at least one of a payment service, a transport service, a shipping service, a storage service, a revenue management service, a toll service, a membership service, an accounting service, a monitoring service, a tracking service, a notification service, and a communication service.
